(19) United States
(12) Patent Application Publication
(10) Pub. No.: US 2026/0102992 A1
(43) Pub. Date: Apr. 16, 2026

(54) BARRIER FILMS FOR BLISTER PACKAGING USING LIQUID CRYSTAL POLYMERS

(71) Applicant: LIVEO RESEARCH AG, Basal (CH)

(72) Inventors: Carsten Heldmann, Peine (DE); Ajith Sashidharan Nair, Downingtown, PA (US); Andreas Josef Pfefferle, Ehrenkirchen (DE); Burkhardt Poessel-Schmid, Denzlingen (DE)

(21) Appl. No.: 19/355,605

(22) Filed: Oct. 10, 2025

Related U.S. Application Data
(60) Provisional application No. 63/705,749, filed on Oct. 10, 2024.

(51) Int. Cl. B32B 27/08; B32B 7/04; B32B 27/36; B32B 37/12; B32B 38/00

(52) U.S. Cl. CPC B32B 27/08; B32B 7/04; B32B 27/36; B32B 37/12; B32B 38/0036; B32B 2038/0048; B32B 2250/02; B32B 2250/03; B32B 2305/55; B32B 2367/00; B32B 2398/00; B32B 2439/70; B32B 2439/80

(57) ABSTRACT

The present disclosure provides a blister package utilizing a high-barrier film made from liquid crystal polymers (LCPs). Due to their highly ordered molecular structure, LCPs exhibit superior barrier properties against moisture and gases, making them ideal for pharmaceutical and food packaging applications. In some embodiments, the LCP film is laminated onto a polyester substrate, such as amorphous polyethylene terephthalate (APET), using an adhesive system to create a composite that is mechanically strong and thermoformable. The method of production can include forming the LCP film via extrusion or solution casting, orienting it by stretching in one or more directions, annealing to enhance barrier properties, and laminating it to the substrate. In some embodiments, a halogen-free, environmentally friendly packaging solution is provided that addresses the need for high-performance barrier films, offering improved protection for sensitive products.

### CROSS-REFERENCE TO RELATED APPLICATION

This application claims the benefit of priority to U.S. provisional patent application No. 63/705,749 filed on Oct. 10, 2024, the entire contents of which are incorporated herein by reference.

### BACKGROUND

The present disclosure pertains to the field of advanced packaging materials, specifically focusing on barrier films utilized in blister packaging applications. It involves the use of liquid crystal polymers (LCPs) to create blister forming films that provide superior barrier properties against gases and moisture. This innovation addresses the challenges in protecting sensitive products from environmental factors that can compromise quality and shelf life.

This technology is particularly relevant to, but not limited to, the pharmaceutical and food packaging industries, where maintaining product integrity is of paramount importance. By incorporating LCPs into blister packaging, the disclosed approach offers enhanced protection for pharmaceuticals, food items, and other perishable goods, ensuring they remain safe and effective throughout their intended shelf life.

### SUMMARY OF THE DISCLOSURE

Blister packaging is extensively utilized in various industries, particularly in the pharmaceutical and food sectors, to protect sensitive products from environmental degradation such as moisture, oxygen exposure, and microbial contamination. This packaging method not only preserves product integrity but also offers advantages like product visibility, tamper evidence, and unit-dose dispensing, enhancing consumer convenience and safety.

Conventional materials for blister packaging primarily include polyvinyl chloride (PVC), polyethylene terephthalate (PET), Polypropylene (PP). PVC has been widely adopted due to its good formability, clarity, and cost-effectiveness. However, PVC exhibits only low to moderate barrier properties against gases and moisture, which may not suffice for products requiring high protection levels. Additionally, PVC contains chlorine, and its production and disposal have raised significant environmental and health concerns. The incineration of PVC can lead to the release of hazardous substances such as dioxins and furans, prompting regulatory agencies and industries to seek safer alternatives.

PET, including its amorphous form (APET), offers better mechanical strength and clarity compared to PVC but, in general, still falls short in barrier performance against moisture and oxygen. PP has a better barrier compared to PVC and PET, but it is still not sufficient to protect moisture-sensitive products. To enhance barrier properties, these materials are often combined with additional layers or coatings of substances like polyvinylidene chloride (PVDC), poly chloro trifluoro ethylene (PCTFE) or aluminum foil. While these multilayer structures improve barrier performance, they introduce complexities in manufacturing and recycling processes. The incompatibility of different materials in multilayer films can hinder recyclability and increase environmental impact.

Liquid crystal polymers (LCPs) have emerged as promising candidates for advanced packaging and electronic applications due to their unique molecular structure and material properties. LCPs consist of rigid, rod-like polymer chains that maintain an ordered structure even in the melt phase. In contrast, semi-crystalline polymers exhibit a random coil arrangement when in the melt state, indicating less molecular order. This high degree of structural continuity in LCPs, which persists even under processing conditions, leads to distinct performance advantages in manufacturing and end-use applications.

LCPs melt over a range of temperatures and exhibit a low heat of fusion compared to semi-crystalline polymers transition sharply from a random coil to a lamellar structure when solidified. Amorphous polymers, meanwhile, gradually soften without a sharp melting point. LCPs, with their extended and ordered chain structures, facilitate more controlled melting and cooling processes, making them ideal for precise thermal control during processes like molding and extrusion. The lower heat of fusion in LCPs allows for more energy-efficient processing compared to both semi-crystalline and amorphous polymers.

Unlike amorphous polymers, where polymer chains exhibit random orientation in both the solid and melt phases, LCPs maintain a high degree of molecular order due to their rod-like structure. Even in the melt phase, LCP molecules align along the flow direction during processing, similar to semi-crystalline polymers but with a higher degree of continuity. This alignment results in an ordered nematic structure that provides LCPs with superior mechanical strength and dimensional stability, making them ideal for high-stress applications such as electronic components or aerospace materials. The semi-crystalline polymers, in contrast, form a less ordered lamellar structure in the solid state, which, while providing good mechanical properties, does not match the high performance of LCPs.

One of the most significant advantages of LCPs is their ability to flow extremely well under shear within their melting range. When directly compared, amorphous polymers and semi-crystalline polymers do not exhibit the same level of flowability. The nematic structure of LCPs during processing contributes to their superior processability in methods such as injection molding. The alignment of LCP chains during flow directly influences mechanical properties like shrinkage, making them suitable for producing intricate, high-precision components.

In applications requiring reinforced polymers, LCPs exhibit a considerable advantage. Reinforcement not only enhances load-bearing capabilities and Deflection Temperature Under Load (DTUL) but also reduces the inherent anisotropy present in LCPs. While reinforcement like fiberglass and mineral additives slightly improve the DTUL of amorphous polymers, it has been found that LCPs show significant improvement, akin to highly crystalline polymers due to their already ordered molecular structure.

LCPs are particularly advantageous for use in high-performance applications such as advanced packaging, electronics, automotive components, and other areas requiring high mechanical strength, thermal stability, and precise molding. The extended chain structure of LCPs, in contrast to the random coil and lamellar structures in semi-crystalline polymers, leads to superior performance in demanding applications. Amorphous polymers like polycarbonate (PC) or acrylonitrile-butadiene-styrene (ABS), as well as semi-crystalline polymers like polyamide or thermoplastic polyesters, serve more general-purpose roles, balancing cost and performance but lacking the structural and mechanical advantages seen in LCPs. In the finished product, LCP molecules are aligned on the surface, forming a skin layer that is highly oriented in the flow direction. This skin layer constitutes approximately 15-30% of the material's total thickness. The molecular orientation within this layer leads to a self-reinforcement effect, imparting exceptional flexural and impact strength, as well as enhanced tensile performance. Notably, the relative strength of LCP materials increases as the wall thickness decreases, making them highly suitable for thin-film applications like blister packaging.

Incorporating LCPs into blister packaging could potentially overcome the limitations of conventional materials by providing superior barrier performance without the need for additional barrier layers or complex multilayer structures. Such improvements could lead to simplified packaging designs, improved recyclability, and reduced environmental impact, all while maintaining or enhancing the protective functions required for sensitive products.

There is a clear need for advancements in blister packaging technology that leverage the unique properties of LCPs. Such developments would address the ongoing challenges of protecting sensitive products from environmental factors, meeting regulatory requirements, and minimizing environmental footprints. The present disclosure aims to fill this gap by introducing blister packaging solutions that utilize LCPs to achieve high barrier properties, offering significant benefits to the pharmaceutical, food, and related industries.

In accordance with embodiments of the present invention, apparatus, methods, and articles of manufacture can be provided that a solution for enhancing the barrier performance of blister packaging by utilizing liquid crystal polymers (LCPs). These materials exhibit unique properties due to their highly ordered liquid crystal structure, where rigid, rod-shaped molecules are oriented in the flow direction during processing methods such as injection molding or extrusion. This molecular orientation results in a self-reinforcement effect, significantly enhancing mechanical properties like flexural and impact strength, especially as wall thickness decreases. The oriented molecules form a skin layer on the surface, constituting approximately 15-30% of the material's total thickness, which contributes to the exceptional barrier properties against moisture and oxygen permeation.

Incorporating LCPs into multi-layer structures can provide exceptional resistance to environmental factors, making them ideal for protecting sensitive products. In at least some embodiments, the embodiment involves the lamination of LCP films onto a secondary polymer layer, such as polyester (e.g., Amorphous Polyethylene Terephthalate, APET), to create a composite film that is both mechanically strong and thermoformable. The lamination can be achieved using adhesive systems to securely bond the layers. Additionally, the blister forming film may be oriented by stretching in one or more directions and annealed to further enhance its barrier properties and mechanical strength. This approach can result in blister packaging that offers superior protection and maintains product integrity, particularly suited for applications in pharmaceutical and food packaging industries.

In some embodiments, a blister package comprises a rupturable lidding substrate and a blister forming film consisting of liquid crystal polymer (LCP).

The substrate may comprise a polyester material. The polyester may be Amorphous Polyethylene Terephthalate (APET). The substrate may be laminated to the LCP blister forming film to form the blister cavity.

The lamination may be achieved using an adhesive system.

The LCP blister film may be formed using processes such as extrusion, blow molding, or solution casting. The LCP may be halogen-free and may comprise an aromatic polyester. The blister film may be coated with an additional layer. The blister forming film may be oriented by stretching in one or more directions. The oriented blister film may be annealed.

In some embodiments, a method of manufacturing a blister package by thermoforming the blister forming film comprising LCP and overlaying the cavity by the rupturable lidding film to the blister forming film by heat sealing process. The method may further comprise orienting the LCP containing blister forming film by stretching in one or more directions to enhance its barrier properties and thermoformability. The method may further comprise annealing the oriented blister forming film to improve its isotropic property. The method may further comprise coating the blister forming film with an additional layer. The method may further comprise laminating the blister forming film with another polymer material to form a multilayer film. The rupturable lidding substrate may comprise a polyester material. The polyester material may be Amorphous Polyethylene Terephthalate (APET). The LCP may be halogen-free and may comprise an aromatic polyester. The method may further comprise applying an adhesive system to laminate the substrate to the blister forming film.

### BRIEF DESCRIPTION OF DRAWINGS

FIG. 1 depicts a representation of the WVTR results for the liquid crystal polymer (LCP) film obtained from cell A in accordance with one or more embodiments of the present invention.

FIG. 2 depicts a representation of the WVTR results of the liquid crystal polymer (LCP) film obtained from cell B in accordance with one or more embodiments of the present invention.

FIG. 3 shows a laminated structure of the LCP film and the amorphous polyethylene terephthalate (APET) substrate, bonded together using an adhesive system in accordance with one or more embodiments of the present invention.

FIG. 4 presents a laminated film thermoformed by a Sepha EZ blister in accordance with one or more embodiments of the present invention.

FIG. 5 illustrates the blister cavities formed from a mono APET film by a TF1 thermoformer in accordance with one or more embodiments of the present invention.

FIG. 6 depicts the formation of blister cavities using the LCP/APET laminated film by a TF1 thermoformer in accordance with one or more embodiments of the present invention.

### DETAILED DESCRIPTION OF EMBODIMENTS

Hereinafter, embodiments disclosed in the present specification will be described in detail with reference to the accompanying drawings. The same or similar constituent elements are assigned with the same reference numerals regardless of reference numerals, and the repetitive description thereof will be omitted.

As used herein, the term “Liquid crystal polymers (LCPs)” refer to a class of polymers characterized by a highly ordered crystalline structure, even in the molten stage. These polymers consist of rigid, rod-shaped molecules that align in the flow direction during processing methods such as injection molding or extrusion. This molecular orientation results in materials with exceptional mechanical and barrier properties. It would be understood to those of ordinary skill in the art that in this definition, “consist of” does not mean that these polymers only have rigid, rod-shaped molecules that align in the flow direction during processing methods such as injection molding or extrusion.

As used herein, the term “blister package” refers to a type of packaging that includes a thermoformed plastic cavity (blister) and a backing lidding substrate. The blister cavity houses the product, and the substrate seals the package, providing protection against environmental factors.

As used herein, the term “substrate” refers to a lid that overlays the blister forming film to create a sealed cavity. The substrate provides mechanical support and can be made from materials such as amorphous polyethylene terephthalate (APET). The lid can be adapted to be ruptured or removed (opened) to open the blister cavity (and access the content).

As used herein, the term “orientation” refers to the process of stretching a polymer film in one or more directions, which aligns the polymer chains along the direction of the stretch.

As used herein, the term “annealing” refers to a heat treatment process applied to polymer films after they have been stretched or oriented. During annealing, the film is heated and then cooled slowly.

As used herein, the term “consist essentially of”, when used with reference to a blister package, means that the blister package can have minor amounts of other ingredients that would not materially affect the present disclosure's function and/or objective in the amount of, for example, less than 10% of the total weight of the blister package. The objective of the present disclosure, when referring to the term “consist essentially of,” includes providing a blister package that achieves enhanced barrier performance, particularly in terms of moisture and gas resistance, while maintaining mechanical strength and processability. The blister package may contain minor amounts of other ingredients that do not significantly affect these primary functions, such as additives for improving adhesion, processing aids, or stabilizers, as long as they are present in amounts less than 10% of the total weight of the blister package. These additional components must not interfere with the blister forming film's ability to deliver the desired level of barrier properties, mechanical integrity, or environmental compliance, including the use of halogen-free materials.

As used herein, the term “rupturable”, when used with reference to a part of a blister package, means that the part at least partially forms an engraving or etching to reduce push through force of the part. Methods for creating the engraving or etching on a substrate, or the substrate itself, can be found, for example, in U.S. Patent Publication Nos. US20240182222A1 and US20240190634A1, both of which are incorporated herein by reference in their entirety. Additionally, U.S. patent application Ser. No. 18/147,799 is also incorporated herein by reference in its entirety.

As used herein, the term “halogen-free” refers to materials that do not contain halogen elements, such as fluorine, chlorine, bromine, iodine, and astatine,

As used herein, the term “aromatic polyester” is a type of polyester polymer that contains aromatic (ring-shaped, often based on benzene) structures in its chemical backbone.

The present disclosure provides a solution for enhancing the barrier performance of blister packaging by utilizing liquid crystal polymers (LCPs). LCPs are a class of polymers characterized by their highly ordered crystal structure, even in its molten stage, where rigid, rod-shaped molecules are oriented in the flow direction during processing methods such as injection molding or extrusion. This molecular orientation results in a self-reinforcement effect, significantly enhancing mechanical properties like flexural and impact strength, especially as wall thickness decreases. The oriented molecules form a skin layer on the surface, constituting approximately 15-30% of the material's total thickness, which contributes to exceptional barrier properties against moisture and oxygen permeation.

LCPs suitable for this application include commercially available brands such as Vectra® by Celanese and Zenite® by DuPont. These LCPs are halogen-free aromatic polyesters, typically composed of monomers like p-Hydroxybenzoic acid (PHB), 2-Hydroxy-6-naphthoic acid (HNA), terephthalic acid (TPA), and bisphenol. They exhibit high thermal stability, chemical resistance, mechanical strength, and low permeability to gases and moisture, making them ideal for barrier films in blister packaging. Other suitable LCPs include Xydar® by Solvay Specialty Polymers and Siveras™ by Toray Industries, which also offer excellent barrier properties. These polymers share key characteristics such as high thermal stability, chemical resistance, mechanical strength, and exceptional barrier properties, making them suitable for demanding applications in packaging.

To produce barrier films for blister packaging, the LCPs are processed into films using techniques such as extrusion, solution casting, or blow molding. In extrusion, the purified LCP is heated until it melts and then forced through a flat die to form a thin film with precise thickness control. Solution casting involves dissolving LCPs in a suitable solvent and then casting the solution onto a substrate; the solvent is subsequently evaporated to leave behind a uniform thin film. Blow molding can also be employed to form films, where the LCP is extruded into a tubular shape and then expanded to form a film.

To enhance the barrier properties, the LCP film may undergo orientation and annealing. During orientation, the film is stretched in one or more directions, aligning the polymer chains and improving the density of the material. This alignment reduces the free volume within the polymer matrix, thereby enhancing the barrier characteristics against gases and moisture. Annealing involves heat-treating the oriented film to stabilize its structure and relieve internal stresses induced during stretching. This process locks in the molecular orientation, ensuring consistent barrier properties and mechanical strength.

In some embodiments, the LCP film is then laminated onto a secondary polymer layer, such as polyester materials like amorphous polyethylene terephthalate (APET), to create a composite film that is both mechanically strong and thermoformable. The lamination is achieved using adhesive systems that securely bond the layers together. This multilayer structure combines the excellent barrier properties of LCPs with the mechanical strength, clarity, and ease of processing provided by materials like APET. The blister forming film may also be coated with additional layers to further enhance barrier properties or to provide specific surface characteristics. Laminating the LCP film with other polymers allows for customization of mechanical and barrier properties to meet specific packaging requirements.

The blister package comprises a rupturable lidding substrate and a blister forming film made of LCP, overlaid by the substrate to create a cavity between them. The rupturable lidding substrate, such as APET, provides mechanical strength and clarity, designed to be easily ruptured for product access while maintaining package integrity. The blister forming film formed from the LCP film offers exceptional barrier properties to protect against environmental factors. This configuration is achieved through lamination and thermoforming processes, where the laminated structure is shaped to form the blister cavity.

The blister package may be child resistant and senior friendly. Preferably, the blister package may be child resistant and senior friendly, according to the guidance or requirement of an agency or authority such as FDA, CPSC (Consumer product safety commission). In some embodiments, the push through force of the substrate or lid film of the blister package is higher than the child resistant requirement and the senior friendly requirement mandated by an agency or authority.

The method of manufacturing the blister package involves providing a rupturable lidding substrate and a blister forming film comprising LCP and overlaying the substrate with the blister forming film to create a cavity between them. The LCP is formed into a film using extrusion, solution casting, or blow molding. The blister forming film may be oriented by stretching the LCP film in one or more directions to enhance its barrier properties, followed by annealing to stabilize the oriented structure. An adhesive system is applied to laminate the LCP film onto the substrate, forming a secure bond. The laminated structure is then thermoformed to create the blister cavity. Additional layers or coatings may be applied to the blister forming film to further enhance its properties.

This approach results in blister packaging that offers superior protection and maintains product integrity, particularly suited for applications in pharmaceutical. By leveraging the unique properties of LCPs, the disclosed blister package provides enhanced barrier performance without the need for complex multilayer structures or environmentally concerning materials like polyvinyl chloride (PVC). The incorporation of LCPs into blister packaging addresses the need for high-performance, environmentally friendly packaging solutions that protect sensitive products from environmental degradation.

For example, a blister package may be constructed using an APET substrate and a Vectra® LCP blister forming film. The Vectra® LCP is extruded into a film and then stretched biaxially to orient the polymer chains. The oriented film is annealed at a temperature below its melting point to stabilize the structure. An adhesive system is applied to laminate the LCP film onto the APET substrate. The laminated structure is then thermoformed to create the blister cavity, resulting in a package with superior barrier properties and mechanical strength.

In another example, a blister package may utilize a coated LCP blister forming film. Zenite® LCP is cast into a film via solution casting and then oriented uniaxially. An additional barrier coating is applied to the LCP film to further enhance its barrier properties. The coated LCP film is laminated onto the substrate, and the blister cavity is formed through thermoforming. This configuration provides a customized barrier performance suitable for specific product requirements.

The disclosed blister packaging offers several advantages. The enhanced barrier performance provided by the LCP layer significantly improves resistance to moisture and oxygen permeation, extending the shelf life of sensitive products. The mechanical strength derived from the self-reinforcement effect of oriented LCPs ensures package durability and integrity. Environmental compliance is achieved through the use of halogen-free LCPs, addressing concerns associated with materials like PVC. The manufacturing methods allow for efficient processes with potential cost savings due to simplified multilayer structures. Customization of barrier and mechanical properties is possible through orientation, annealing, and multilayer configurations, enabling tailoring to specific application needs.

Applications of this technology include pharmaceutical packaging, where protecting medications from moisture, oxygen, and other environmental factors is important to maintaining efficacy. In food packaging, the blister packages help preserve freshness and quality by preventing spoilage due to environmental exposure. For medical devices, the packaging ensures sterility and integrity of products sensitive to environmental conditions.

The present disclosure introduces blister packaging solutions that utilize LCPs to achieve high barrier properties, offering significant benefits to industries requiring enhanced protection for sensitive products. By incorporating LCPs into blister packaging, the disclosed approach overcomes the limitations of conventional materials, provides environmental advantages, and meets the ongoing challenges of product protection, regulatory compliance, and environmental responsibility.

The following examples illustrate embodiments of the disclosure and are not intended to limit its scope.

### EXAMPLE 1: MEASUREMENT OF WATER VAPOR TRANSMISSION RATE (WVTR) OF LCP BARRIER FILM

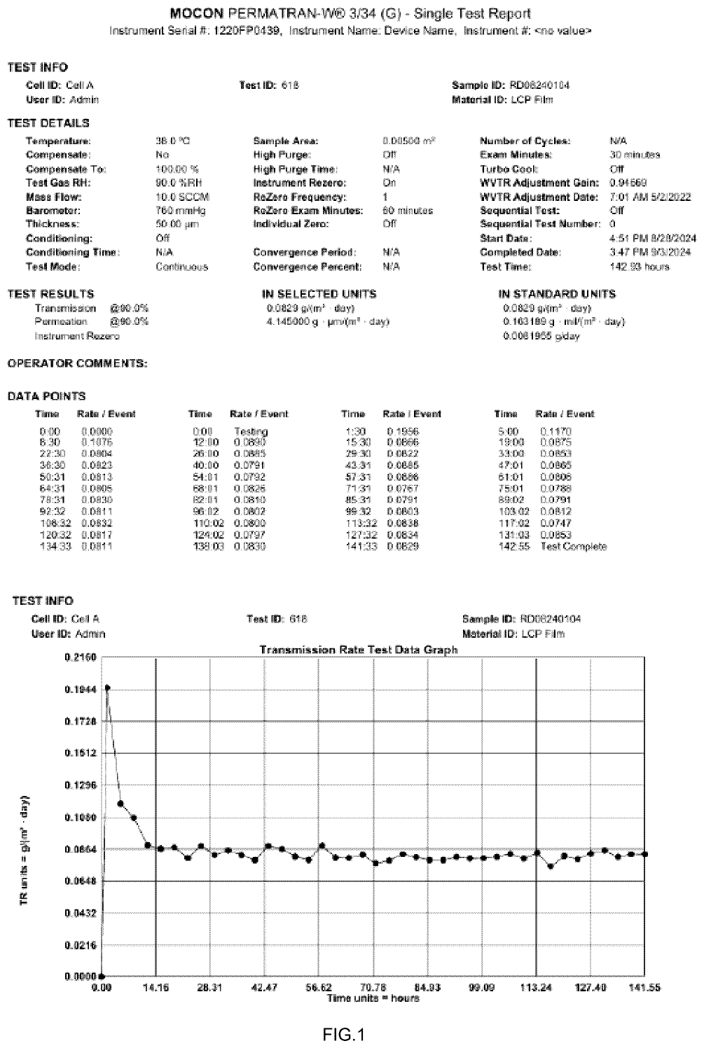

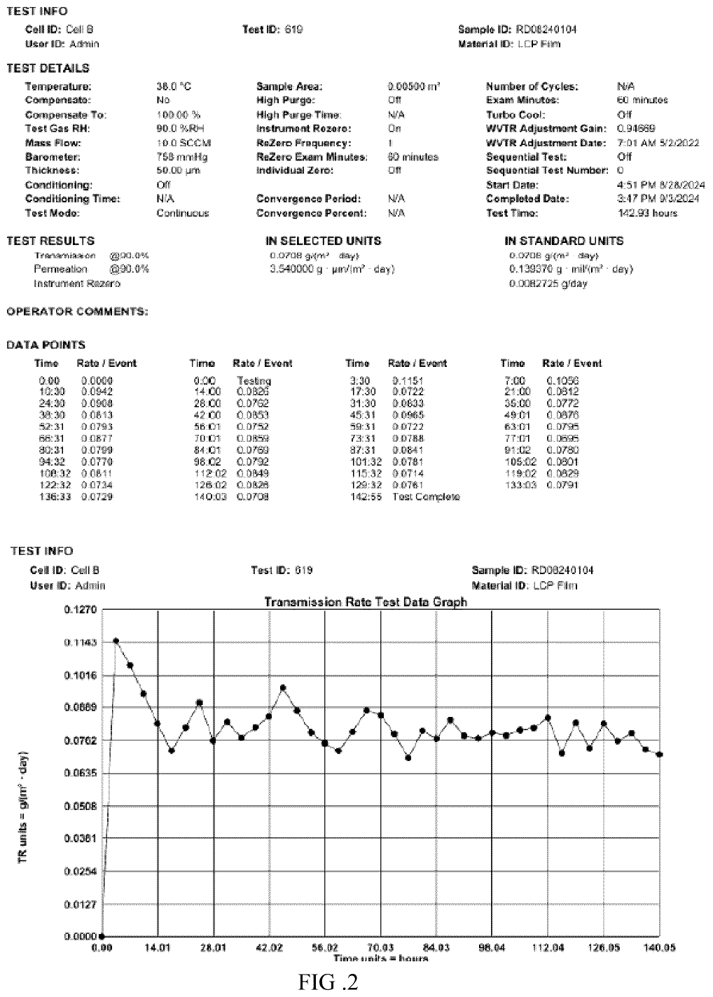

A sample of LCP film with a thickness of 100 microns was prepared. The water vapor transmission rate (WVTR) of the LCP film was measured using the ASTM F1249 standard test method at 38° C. and 90% relative humidity. To determine test repeatability, the measurements were conducted in two separate cells simultaneously, as shown in FIGS. 1 and 2. The results were as follows:
Cell A: WVTR=0.0829 g/m²/day
Cell B: WVTR=0.0708 g/m²/day
Average WVTR: 0.0769 g/m²/day

These results indicate that the LCP film provides an excellent barrier to moisture, with WVTR values comparable to high-barrier films such as Aclar® 3000 or AquaBa 150, which typically exhibit WVTR values around 0.08 g/m²/day.

### EXAMPLE 2: LAMINATION OF LCP FILM TO APET SUBSTRATE

An adhesive system comprising Aqualam® and a hardener was prepared according to standard mixing ratios (108 parts Aqualam to 12.6 parts hardener). The adhesive was applied to a 250-micron APET sheet using an 8-micron bar coater and dried in an oven for 30 seconds. The LCP film was then laminated to the APET sheet using a cold press lamination machine. After two hours, the adhesion was tested qualitatively by hand and found to be successful, exhibiting good adhesion between the LCP film and the APET substrate.

### EXAMPLE 3: MEASUREMENT OF ADHESION STRENGTH OF LAMINATED FILM

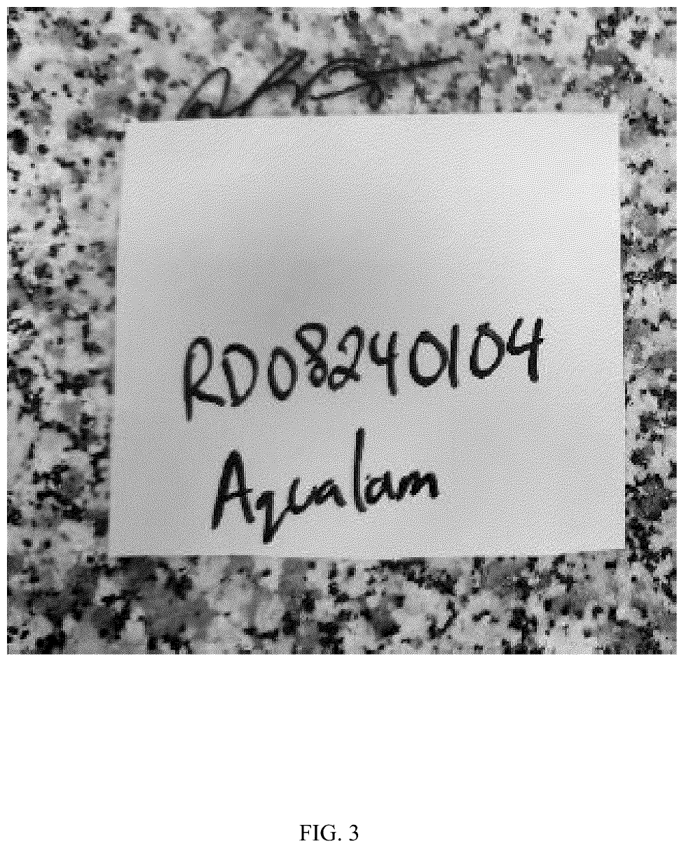

Following the lamination as shown in FIG. 3, the adhesion strength of the LCP/APET laminated film was quantitatively measured using a tensile testing machine at a test speed of 300 mm/min, adapted from USP 1207.3. The target adhesion strength was greater than or equal to 0.25 kgf/cm, which is typical for PVC/Aclar® laminations. The measured adhesion strengths were:
Test 1: 0.4859 kgf/cm
Test 2: 0.3472 kgf/cm
Test 3: 0.3500 kgf/cm
Average adhesion strength: 0.3944 kgf/cm

These values indicate that the adhesion strength of the LCP/APET laminate is comparable to that of conventional PVC/Aclar® laminations, demonstrating the effectiveness of the adhesive system in bonding the two materials.

### EXAMPLE 4: THERMOFORMABILITY TESTING OF LAMINATED FILM

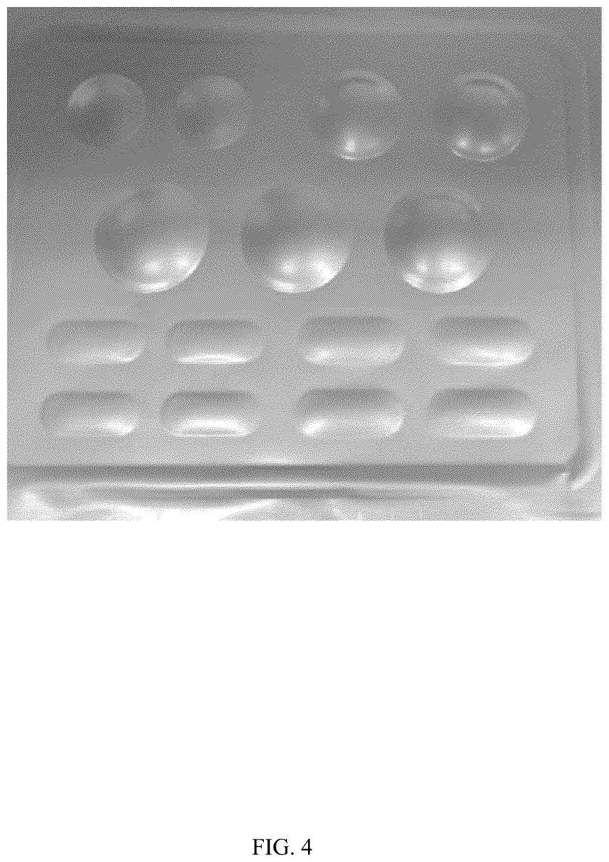

The thermoformability of the LCP/APET laminated film was evaluated using a tabletop thermoforming machine set at a forming temperature of 125° C. During the forming process using a Sepha EZ blister, the blister cavities did not fully form, as shown in FIG. 4, and an audible hissing sound indicated that the seal for forming was compromised. This suggested that the sample size might have been too small or that the forming temperature was insufficient for the LCP layer.

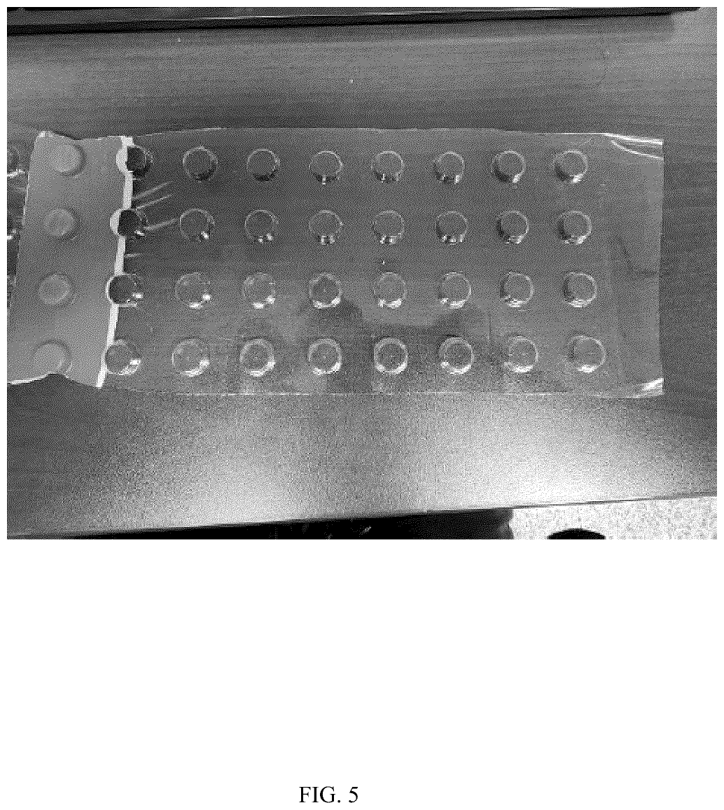

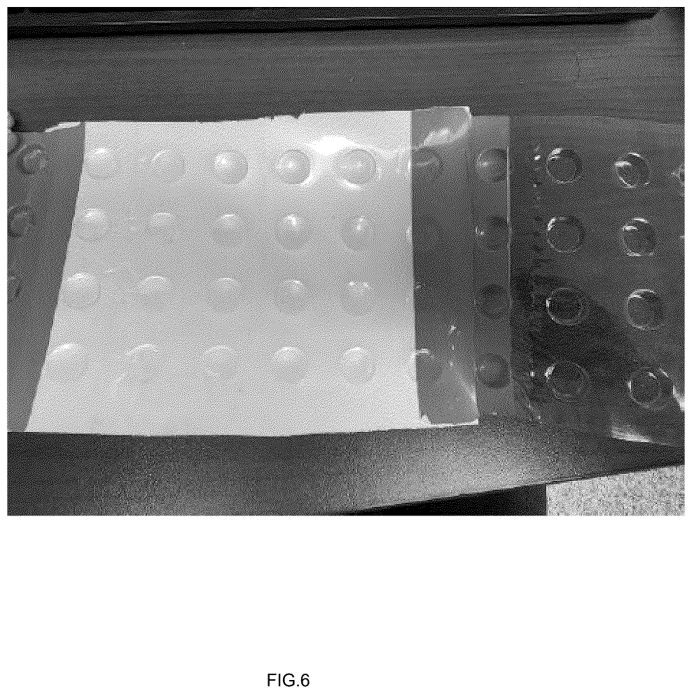

To further investigate, the laminated film was tested on a standard thermoforming machine (i.e., TF1 thermoformer) with the contact preheat stations set at 130° C. A mono APET film was first processed to confirm proper machine operation, resulting in excellent cavity formation, as shown in FIG. 5. When the LCP/APET laminated film was processed under the same conditions, the blister cavities did not fully form, indicating that the LCP layer requires a higher forming temperature due to its higher softening point compared to APET, as shown in FIG. 6.

Despite incomplete formation, inspection of the LCP film revealed no noticeable tears or cracking, suggesting that the LCP layer possesses sufficient thermo-stretchability and can withstand higher forming temperatures without degradation.

The preliminary tests demonstrate that LCP films laminated to APET substrates provide excellent moisture barrier properties and exhibit good adhesion strength using standard adhesive systems. The WVTR values of the LCP film are comparable to those of high-performance barrier films, indicating its suitability for applications requiring moisture protection.

While the thermoformability of the LCP/APET laminated film requires higher forming temperatures than conventional materials, the LCP layer shows potential for successful thermoforming with appropriate temperature adjustments. The absence of tearing or cracking during forming suggests that the material can accommodate the stresses involved in the thermoforming process.

It would be understood to those of ordinary skill in the art that blister forming film can include (e.g., depending on the application or implementation) one or more layers, additives, coloring agents, mixtures of polymers, or other material or structures. An objective is to make or include in the blister forming film an amount of LCP in the blister forming film that provides the desired level of barrier performance such as comprising at least 95%, 90%, 85%, 80%, 75%, 70%, 65%, 60%, or 50% LCP by weight. For example, depending on the application if desired, other types of polymers such as a semi-crystalline polymer can be included in the blister forming film. If desired, the lid can be a polymer lid such as to allow for recycling or can include aluminum foil as a cover.

In some embodiments, the blister forming film may consist essentially of LCP or a combination of LCP and other polymers, allowing for minor additives or components (e.g., less than 10% by weight) that do not materially affect the barrier performance or mechanical properties. In some embodiments, the blister forming film may consist of 100% LCP, or a combination of LCP and other polymers to ensure desired barrier performance without any additional materials.

The blister package contains two components, one is blister forming substrate where the product is filled and Lidding component which is used as the closure. Both can be made with different materials or it may be an all-plastic single material or single component device, which is easy to recycle. The blister package can be produced to consist of the same plastic or class plastic (e.g., of the types described herein). The single component blister package that produced essentially of the same plastic or the same class of plastic (e.g., of the types described herein) wherein the objective is to have a recyclable (single-stream or two-stream recycling) structure. The blister package can be recycled chemically, mechanically, energetically, or by any other means In some embodiments, minor amounts of or residual materials other than the plastic can be included in the film or blister side and in recycling applications, the amounts are adapted not to change the recyclable characteristic of the blister package (lid film and blister side To clarify, with respect to this paragraph, the blister package refers to the embodiments illustratively described herein. In some embodiments, the blister package may have minor amounts of other ingredients in the amount of less than about 10% of the total weight of the blister package. The lid film may also be made to be translucent, opaque, or colored per the product specification or safety requirement. In some embodiments, the lid film may be opaque or colored to preserve the photosensitive/photoreactive properties of the cavity contents. In some embodiments, the lid film may be free from other additives than cavitating agents; plasticizers; or other materials that may affect the translucency or color of the lid film. In some embodiments, an opaque or colored lid may be incorporated as a child-resistant feature of the package. Preferably, the blister package may be child-resistant and senior-friendly according to the guidance or requirement of an agency or authority such as the Food and Drug Administration (FDA) or European Medicines Agency (EMEA).

As used herein, the term “same class”, when used with reference to a plastic, refers to a plastic comprising the same majority of monomeric units and/or that can go to the same stream of recycling (meeting the same composition requirement for that recycling stream). As used herein, the term “plastics” are synthetic polymeric materials derived from petroleum. In some embodiments, the term “majority” means about 99%, about 98%, about 97%, about 96%, about 95%, about 94%, about 93%, about 92%, about 91%, about 90%, about 85%, about 80%, about 75%, about 70%, about 65%, about 60%, about 55%, about 50%.

The disclosure offers several advantages, including enhanced barrier performance, mechanical strength, environmental compliance due to the halogen-free nature of LCPs, and the potential for efficient manufacturing processes. By leveraging the unique properties of LCPs, the disclosed blister packaging provides an effective and environmentally friendly solution for protecting sensitive products from environmental degradation.

While the specific embodiments of the present disclosure have been illustrated and described, it will be obvious to those skilled in the art that the present disclosure may be variously modified and changed without departing from the technical spirit of the present disclosure defined in the appended claims.

It should be understood that variations, clarifications, or modifications are contemplated. Applications of the technology to other fields not mentioned are also contemplated.

Exemplary methods and compositions are described. Since numerous modifications and changes will readily be apparent to those having ordinary skill in the art, it is not desired to limit the disclosure to only the exact constructions as demonstrated in this disclosure. Accordingly, all suitable modifications and equivalents may be resorted to falling within the scope of the disclosure.

Thus, for example, any sequence(s) and/or temporal order of steps of various processes or methods that are described herein are illustrative and should not be interpreted as being restrictive except as it would be generally understood from the context and description. Accordingly, it should be understood that although steps of various processes or methods or connections or sequence of operations may be shown and described as being in a sequence or temporal order, but they are not necessarily limited to being carried out in any particular sequence or order. For example, the steps in such processes or methods generally may be carried out in various different sequences and orders, while still falling within the scope of the present disclosure.

It should be understood that claims that include fewer limitations, broader claims, such as claims without requiring a certain feature or process step in the appended claim or in the specification, clarifications to the claim elements, different combinations, and alternative implementations based on the specification, or different uses, are also contemplated by the embodiments of the present disclosure.

It should be understood that combinations of described features or steps are contemplated even if they are not described directly together or not in the same context.

The terms or words that are used herein are directed to those of ordinary skill in the art in this field of technology and the meaning of those terms or words will be understood from terminology used in that field or can be reasonably interpreted based on the plain English meaning of the words in conjunction with knowledge in this field of technology. This includes an understanding of implicit features that for example may involve multiple possibilities, but to a person of ordinary skill in the art a reasonable or primary understanding or meaning is understood.

Embodiments of the present disclosure can include methods and/or compositions.

The terms “may” or “can” (or similar terms) are sometimes used herein to communicate that embodiments of the disclosure include the described features, attributes, or characteristics but are not necessarily limited to that feature, attribute, or characteristic. This is not to say that the use of “is” or “are” (or similar terms) are used to communicate that embodiments of the present disclosure are limited to that described feature, attribute, or characteristic.

It should be understood that the above description of the disclosure and specific examples, while indicating preferred embodiments of the present disclosure, are given by way of illustration and not limitation. Many changes and modifications within the scope of the present disclosure may be made without departing from the spirit thereof, and the present disclosure includes all such changes and modifications.

What is claimed is:

1. A blister package comprising:
a rupturable lidding substrate,
a blister forming film comprising liquid crystal polymer (LCP) overlayed by the substrate, thereby making a cavity between the rupturable substate and the blister forming film.

2. The blister package of claim 1, wherein the substrate comprises a polyester.

3. The blister package of claim 2, wherein the polyester is Amorphous Polyethylene Terephthalate (APET).

4. The blister package of claim 1, wherein the substrate is laminated to the blister forming film.

5. The blister package of claim 4, wherein the substrate is laminated to the blister forming film using an adhesive system.

6. The blister package of claim 1, wherein the blister forming film is formed using extrusion, blow molding, solution casting or blow molding.

7. The blister package of claim 1, wherein the LCP is halogen-free and comprises an aromatic polyester.

8. The blister package of claim 1, wherein the blister forming film is coated with an additional layer.

9. The blister package of claim 1, wherein the blister forming film is oriented by stretching in one or more directions.

10. The blister package of claim 1, wherein the oriented blister forming film is annealed.

11. A method of manufacturing a blister package comprising:
providing a rupturable lidding substrate,
providing a blister forming film comprising liquid crystal polymer (LCP), and
overlaying the substrate with the blister forming film to create a cavity between the rupturable lidding substrate and the blister forming film.

12. The method of claim 11, further comprising forming the blister forming film using extrusion, blow molding, or solution casting.

13. The method of claim 12, further comprising orienting the blister forming film by stretching the LCP film in one or more directions to enhance its barrier properties.

14. The method of claim 13, further comprising annealing the oriented blister.

15. The method of claim 11, further comprising coating the blister forming film with an additional layer.

16. The method of claim 11, further comprising laminating the blister forming film with another polymer material to form a multilayer film.

17. The method of claim 11, wherein the rupturable lidding substrate comprises a polyester material.

18. The method of claim 17, wherein the polyester material is Amorphous Polyethylene Terephthalate (APET).

19. The method of claim 11, wherein the LCP is halogen-free and comprises an aromatic polyester.

20. The method of claim 11, further comprising applying an adhesive system to laminate the substrate to the blister forming film.
